(19) United States
(12) Patent Application Publication
(10) Pub. No.: US 2024/0272784 A1
(43) Pub. Date: Aug. 15, 2024

(54) APP BILLBOARD FOR PORTABLE COMPUTING DEVICES

(71) Applicant: Relevant Radio, Inc., Lincolnshire, IL (US)

(72) Inventor: Preston L. Allex, Lake Barrington, IL (US)

(73) Assignee: Relevant Radio, Inc., Lincolnshire, IL (US)

(21) Appl. No.: 18/109,391

(22) Filed: Feb. 14, 2023

(51) Int. Cl. G06F 3/04847; G06F 9/445

(52) U.S. Cl. CPC G06F 3/04847; G06F 9/445

(57) ABSTRACT

A method and device for the automatic opening of a lite version of a digital application for display and use on a portable computing device. The lite version uses the components and computing elements of the portable device and is arranged to override the default graphical user interface of the portable computing device by deprioritizing certain system processes. The lite version executes along with a full version of the application wherein the device displays the lite version on a device display. The end user is not required to make direct requests or initiate direct inputs to the full version application in order to invoke the lite version but instead operates through an automated process based on a user's setup of the digital application.

### TECHNICAL FIELD

This disclosure is generally directed to portable computing devices. More specifically, it relates to a method and device for automatically opening and launching lite versions of digital applications for use and display on a portable computing device.

### BACKGROUND

A digital application, also known as an “app”, is simply a computer program created to carry out or facilitate a task on a computing device. Lite versions of digital applications are designed with the end user in mind to supply a simplified method for the display of text, graphics, audio and video or other content on a computing device. The lite version of a digital application contains the most important and relevant benefits to a user using the application. The lite version of an app may have interactive functions selected by the user and selectable links back to the full version of the application. Lite versions of apps may be automatically activated by event triggers selected by the user or automatically invoked when the app is opened. The lite version of an app provides a simpler and more concentrated display of information to a user without additional distractions. Lite versions of apps are more versatile than current known methods of delivering content and information to end users and particularly beneficial in mobile and portable computing devices, such as for example, mobile telephones, tablets or other handheld computing devices.

It is therefore an object of the present disclosure to provide for a method and device for automatically opening and launching lite versions of digital applications for use and display on portable computing devices that makes it easier for the end user to take advantage of an app's benefits.

### SUMMARY

This disclosure relates to a method and device for automatically opening and launching lite versions of digital applications for use and display on a portable computing device.

In a first embodiment a method is disclosed that at a portable computing device having a display comprises, providing a digital application executing on the computing device that includes a lite version of the digital application. The method further comprises, configuring using a management portal the digital application to execute the lite version of the digital application; and displaying the lite version of the application on the display.

In a second embodiment a portable computing device is disclosed comprising; at least one processor, a display, memory, and at least one digital application having a lite version of the digital application stored in the memory and configured by a management portal to be executed by the at least one processor, with instructions for executing the lite version of the digital application and to display the lite version of the digital application on the display.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 is a block diagram illustrating a portable computing device with a touch-sensitive display, in accordance with the present disclosure;

FIG. 2 illustrates an exemplary global settings portal displayed on the device touch-sensitive display, in a accordance with the present disclosure;

FIG. 3 illustrates a first page of an exemplary event trigger menu displayed on the touch-sensitive display, in a accordance with the present disclosure;

FIG. 4 illustrates a second page of an exemplary event trigger menu displayed on the touch-sensitive display, in a accordance with the present disclosure;

FIG. 5 illustrates an exemplary selection screen menu displayed on the touch-sensitive display, in a accordance with the present disclosure;

FIG. 6 illustrates an exemplary customization screen menu displayed on the touch-sensitive display, in a accordance with the present disclosure;

FIG. 7 illustrates an exemplary App Billboard displayed on the touch-sensitive display in accordance with the present disclosure;

FIG. 8 illustrates an exemplary App Billboard selection menu for selecting text shown on the touch-sensitive display of FIG. 7, in accordance with the present disclosure; and

FIG. 9 illustrates an exemplary App Billboard settings screen for selecting specific operations of the App Billboard, in accordance with the present disclosure.

### DETAILED DESCRIPTION

The figures, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

The present disclosure is a method and device for the automatic opening of a lite version of an application for display and use on a portable computing device, such as for example, a mobile telephone or tablet, or other device that uses a digital application. The lite version uses the components and computing elements of the portable device and overriding the default graphical user interface by deprioritizing certain system processes. The present disclosure does not require the end user to make direct requests or initiate direct inputs to the digital application in order to invoke the lite version but instead operates through an automated digital process based on a user's setup of the digital application.

The present disclosure further provides for a method of automatically opening a lite version of a digital application that can be organized and better controlled by the user through a management portal. The management portal providing configuration selections and event triggers for the lite version that prioritize the different processes, which makes the lite version more useful to the end user. For example, the user may select to remove horizontal scrolling functionality in order to accommodate multiple lite versions of the digital applications that may be active through hidden windows and also select what can be shown via horizontal swiping or scrolling. The lite version of a digital application that is automatically activated by event triggers will be hereinafter called in the present disclosure an “App Billboard.”

The management portal allows the end user to select event data, event triggers, or event listener(s), which interface with a digital application and the portable device's operating system that interacts and achieves the automatic opening of the App Billboard on the device when desired by the user. The App Billboard textual content and operating icons can be shown on the portable device display alone or shared with other information from other applications on the entire display screen, duplicated to multiple screens, or extend across multiple screens depending on the device hardware and user configuration.

The App Billboard utilizes the audio, graphics, text, video, and interactive elements of the portable device and can be invoked in both a locked or unlocked state. For example, the App Billboard can be setup to automatically close after a set period of time, setup to have a delayed activation, dynamically change based on an event trigger, or wait until more than one event occurs before activating. The App Billboard via the management portal can be setup to be muted or have a different volume by default, to not activate when the user sets certain parameters, prevent user interaction with the device for a period of time as allowed by user and to have the ability to wake up the portable device.

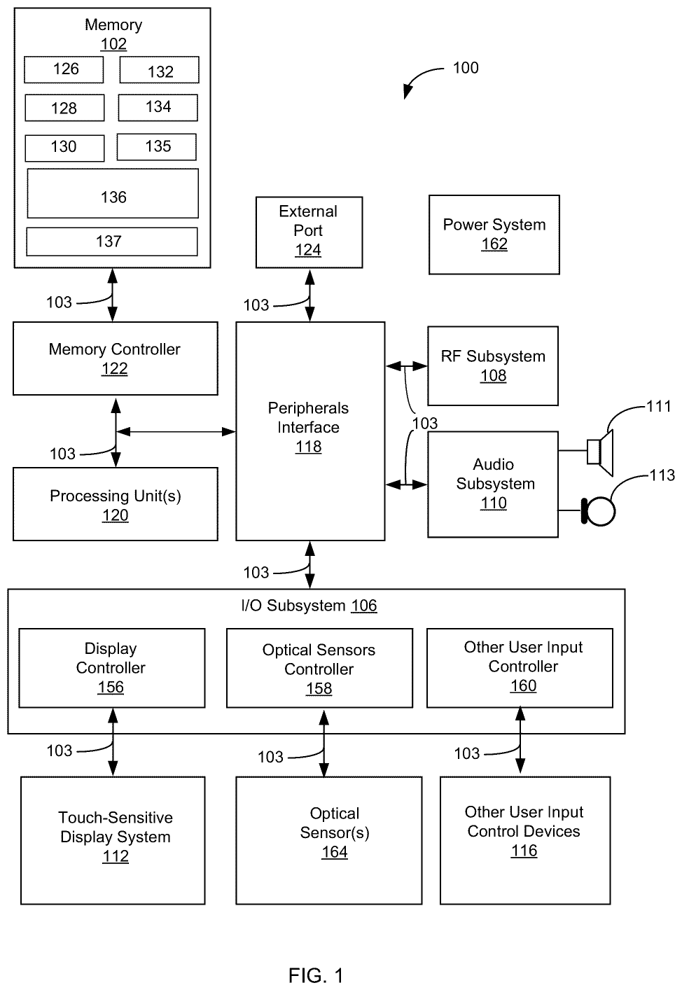

FIG. 1 is a block diagram illustrating a portable computing device 100 with a touch-sensitive display 112 in accordance with the present disclosure. The touch-sensitive display 112 is sometimes called a “touch screen” for convenience and may also be known as or called a touch-sensitive display system. The device 100 may include a memory 102 (which may include one or more computer readable storage mediums), a memory controller 122, one or more processing units (CPU's) 120, a peripherals interface 118, radio frequency (RF) subsystem 108, an audio subsystem 110, a speaker 111, a microphone 113, an input/output (I/O) subsystem 106, other user input control devices 116, and an external port 124. The device 100 may include one or more optical sensors 164. These components may communicate over one or more communication buses or signal lines 103.

It should be appreciated that the device 100 is only one example of a portable computing device 100, and that the device 100 may have more or fewer components than shown, may combine two or more components, or a may have a different configuration or arrangement of the components. The various components shown in FIG. 1 may be implemented in hardware, software or a combination of both hardware and software, including one or more signal processing and/or application specific integrated circuits.

Memory 102 may include high-speed random access memory and may also include non-volatile memory, such as one or more magnetic disk storage devices, flash memory devices, or other non-volatile solid-state memory devices. Access to memory 102 by other components of the device 100, such as the CPU 120 and the peripherals interface 118, may be controlled by the memory controller 122.

The peripherals interface 118 couples the input and output peripherals of the device to the CPU 120 and memory 102. The one or more processors 120 run or execute various software programs and/or sets of instructions stored in memory 102 to perform various functions for the device 100 and to process data. In some embodiments, the peripherals interface 118, the CPU 120, and the memory controller 122 may be implemented on a single integrated circuit. In some other embodiments, they may be implemented as separate discrete circuits.

The RF subsystem 108 receives and sends RF signals, also called electromagnetic signals. The RF subsystem 108 converts electrical signals to/from electromagnetic signals and communicates with communications networks and other communications devices via the electromagnetic signals. The RF subsystem 108 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF subsystem 108 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (WiFi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this document.

The audio subsystem 110, the speaker 111, and the microphone 113 provide an audio interface between a user and the device 100. The audio subsystem 110 receives audio data from the peripherals interface 118, converts the audio data to electrical signals, and transmits the electrical signals to the speaker 111. The speaker 111 converts the electrical signals to human-audible sound waves. The audio circuitry 110 also receives electrical signals converted by the microphone 113 from sound waves. The audio circuitry 110 converts the electrical signals to audio data and transmits the audio data to the peripherals interface 118 for processing. Audio data may be retrieved from and/or transmitted to memory 102 and/or the RF subsystem 108 by the peripherals interface 118. In some embodiments, the audio subsystem 110 also includes a headset jack (not shown). The headset jack provides an interface between the audio subsystem 110 and removable audio input/output peripherals, such as output-only headphones or a headset with both output (e.g., a headphone for one or both ears) and input (e.g., a microphone). The audio subsystem 110 may also output very low frequency audio signals to the speaker 111, causing the speaker 111 to vibrate at the low frequency, to provide vibration alarms to the user. Alternately, the peripherals interface 118 may be connected to a haptic or separate vibration transducer (not shown) to cause vibration alarms.

The I/O subsystem 106 couples input/output peripherals on the device 100, such as the touch screen 112 and other input/control devices 116, to the peripherals interface 118. The I/O subsystem 106 may include a display controller 156 and one or more input controllers 160 for other input or control devices. The one or more input controllers 160 receive/send electrical signals from/to other input or control devices 116. The other input/control devices 116 may include physical buttons (e.g., push buttons, rocker buttons, etc.), dials, slider switches, joysticks, click wheels, and so forth. In some alternate embodiments, input controller(s) 160 may be coupled to any (or none) of the following: a keyboard, infrared port, USB port, and a pointer device such as a mouse and one or more buttons (not shown) for controlling the volume control of the speaker 111 and/or the microphone 113. The user may be able to customize a functionality of one or more of the buttons. The touch screen 112 is used to implement virtual or soft buttons and one or more soft keyboards.

The touch-sensitive touch screen 112 provides an input interface and an output interface between the device and a user. The display controller 156 receives and/or sends electrical signals from/to the touch screen 112. The touch screen 112 displays visual output to the user. The visual output may include graphics, text, icons, video, and any combination thereof (collectively termed “graphics”). In certain embodiments, some or all of the visual output may correspond to user-interface objects, further details of which are described below.

A touch screen 112 has a touch-sensitive surface, sensor or set of sensors that accepts input from the user based on haptic and/or tactile contact. The touch screen 112 and the display controller 156 (along with any associated modules and/or sets of instructions in memory 102) detect contact (and any movement or breaking of the contact) on the touch screen 112 and converts the detected contact into interaction with user-interface objects (e.g., one or more soft keys, icons, web pages or images) that are displayed on the touch screen. In the present disclosure, a point of contact between a touch screen 112 and the user corresponds to a finger of the user.

The touch screen 112 may use LCD (liquid crystal display) technology, or LPD (light emitting polymer display) technology, although other display technologies may be used in other embodiments. The touch screen 112 and the display controller 156 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 112. The user may make contact with the touch screen 112 using any suitable object or appendage, such as a stylus, a finger, and so forth. In some embodiments, the user interface is designed to work primarily with finger-based contacts and gestures, which are much less precise than stylus-based input due to the larger area of contact of a finger on the touch screen. In some embodiments, the device translates the rough finger-based input into a precise pointer/cursor position or command for performing the actions desired by the user.

In addition to the touch screen, the device 100 may include a touchpad (not shown) for activating or deactivating particular functions. In some embodiments, the touchpad is a touch-sensitive area of the device that, unlike the touch screen, does not display visual output. The touchpad may be a touch-sensitive surface that is separate from the touch screen 112 or an extension of the touch-sensitive surface formed by the touch screen.

The device 100 also includes a power system 162 for powering the various components. The power system 162 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

The device 100 may also include one or more optical sensors 164. FIG. 1 shows an optical sensor 164 coupled to an optical sensor controller 158 in I/O subsystem 106. The optical sensor 164 may include charge-coupled device (CCD) or complementary metal-oxide semiconductor (CMOS) phototransistors. The optical sensor 164 receives light from the environment, projected through one or more lens, and converts the light to data representing an image. In conjunction with an imaging module 143 (also called a camera module), the optical sensor 164 may capture still images or video. In some embodiments, an optical sensor is located on the back of the device 100, opposite the touch screen display 112 on the front of the device, so that the touch screen display may be used as a viewfinder for either, still and/or video image acquisition. In some embodiments, an optical sensor is located on the front of the device so that the user's image may be obtained for videoconferencing while the user views the other video conference participants on the touch screen display. In some embodiments, the position of the optical sensor 164 can be changed by the user (e.g., by rotating the lens and the sensor in the device housing) so that a single optical sensor 164 may be used along with the touch screen display for both video conferencing and still and/or video image acquisition.

In some embodiments, the software components stored in memory 102 may include an operating system 126, a communication module (or set of instructions) 128, a contact module (or set of instructions) 130, a graphics module (or set of instructions) 132, a text input module (or set of instructions) 134, a Global Positioning System (GPS) module (or set of instructions) 135, and applications 136 (or set of instructions).

The operating system 126, such as for example, Darwin, RTXC, LINUX, UNIX, OS X, WINDOWS, or an embedded operating system such as VxWorks includes various software components and/or drivers for controlling and managing general system tasks (e.g., memory management, storage device control, power management, etc.) and facilitates communication between various hardware and software components.

The communication module 128 facilitates communication with other devices over one or more external ports 124 and also includes various software components for handling data received by the RF subsystem 108 and/or the external port 124. The external port 124 (e.g., Universal Serial Bus (USB), FIREWIRE, etc.) is adapted for coupling directly to other devices or indirectly over a network (e.g., the Internet, wireless LAN, etc.).

The contact module 130 may detect contact with the touch screen 112 (in conjunction with the display controller 156) and other touch sensitive devices (e.g., a touchpad). The contact module 130 includes various software components for performing various operations related to detection of contact, such as determining if contact has occurred, determining if there is movement of the contact and tracking the movement across the touch screen 112, and determining if the contact has been broken (i.e., if the contact has ceased). The contact module may also determine movement of the point of contact such as for example, determining speed (magnitude), velocity (magnitude and direction), and/or an acceleration (a change in magnitude and/or direction) of the point of contact. These operations may be applied to single contacts, such as for example, one finger contacts or to multiple simultaneous contacts, such as for example, multi-touch/multiple-finger contacts. The contact module and the display controller 156 also detects contact on a touchpad.

The graphics module 132 includes various known software components for rendering and displaying graphics on the touch screen 112, including components for changing the intensity of graphics that are displayed. As used herein, the term “graphics” includes any object that can be displayed to a user, including without limitation text, web pages, icons (such as user-interface objects including soft keys), digital images, videos, animations, and the like.

The text input module 134, which may be a component of graphics module and provides soft keyboards for entering text in various applications that needs text input.

The GPS module 135 may be used to determine the location of the portable device and provide this information for use in various applications, for example to a telephone module for use in location-based dialing, to the camera module as picture/video metadata, and to applications that provide location-based services such as weather, local yellow page, and map/navigation applications.

Applications 136 may be installed in the memory 102 include the following applications (or sets of instructions), or a subset or superset thereof: a contacts application (sometimes called an address book or contact list); a telephone application; a video conferencing application; an e-mail client application; a camera and video application for still and/or video images, a music player application; a browser application, and other applications (or sets of instructions) which may include and provide weather, stocks information, calculator, alarm clock, dictionary, and other applications obtained and installed in the memory 102 by the user of device 100.

Examples of other applications that may be stored in memory 102 include memo pad and other word processing applications, JAVA-enabled applications, encryption, digital rights management, voice recognition, and voice replication.

In conjunction with touch screen 112, display controller 156, contact module 130, graphics module 132, and the text input module 134, the contacts module may be used to manage an address book or contact list, including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by various applications such as for example the telephone, video conference, e-mail and so forth.

In conjunction with RF subsystem 108, audio subsystem 110, speaker 111, microphone 113, touch screen 112, display controller 156, the contact module 130, graphics module 132, and text input module 134, the telephone application may be used to enter a sequence of characters corresponding to a telephone number, access one or more telephone numbers in the address book, modify a telephone number that has been entered, dial a respective telephone number, conduct a conversation and disconnect or hang up when the conversation is completed. As noted above, the wireless communication may use any of a plurality of communications standards, protocols, and technologies.

In conjunction with RF subsystem 108, touch screen 112, display controller 156, contact module 130, graphics module 132, and text input module 134, the e-mail client application may be used to create, send, receive, and manage e-mail. In conjunction with image management application, the e-mail application makes it very easy to create and send e-mails with still or video images taken with the camera application.

In conjunction with touch screen 112, display controller 156, optical sensor(s) 164, optical sensor controller 158, contact module 130, graphics module 132, and an image management application, the camera application may be used to capture still images or video (including a video stream) and store them into memory 102, modify characteristics of a still image or video, or delete a still image or video from memory 102.

In conjunction with touch screen 112, display system controller 156, contact module 130, graphics module 132, audio circuitry 110, speaker 111, RF subsystem 108, and browser application, the music player application allows the user to download and play back recorded music and other sound files stored in one or more file formats, such as MP3 or AAC files.

In conjunction with RF subsystem 108, touch screen 112, display system controller 156, contact module 130, graphics module 132, and text input module 134, the browser application, can be used to browse the Internet, including searching, linking to, receiving, and displaying web pages or portions thereof, as well as attachments and other files linked to web pages.

In conjunction with RF circuitry 108, touch screen 112, display system controller 156, contact module 130, graphics module 132, text input module 134, and the browser module, the other downloaded applications may be used by a user, to check the weather, financial information and stocks, operate the calculator, set an alarm clock and/or use a dictionary. In some embodiments, an application may include an HTML (Hypertext Markup Language) file, a CSS (Cascading Style Sheets) file, and a JavaScript file or an XML (Extensible Markup Language) file and a JavaScript file.

Each of the above identified modules and applications correspond to a set of instructions for performing one or more functions described above. These modules (i.e., sets of instructions) need not be implemented as separate software programs, procedures or modules, and thus various subsets of these modules may be combined or otherwise rearranged in various embodiments. In some embodiments, memory 102 may store a subset of the modules and data structures identified above. Furthermore, memory 102 may store additional modules and data structures not described above.

The device 100 is a device where operation of a predefined set of functions on the device is performed exclusively through a touch screen 112 and/or a touchpad. By using a touch screen 112 and/or a touchpad as the primary input/control device for operation of the device 100, the number of physical input/control devices (such as push buttons, dials, and the like) on the device 100 is reduced.

The predefined set of functions that may be performed exclusively through a touch screen 112 include navigation between user interfaces. In some embodiments, the touchscreen may include an icon button, that when touched by the user, navigates the device 100 to a main, home, or root menu from any user interface that may be displayed on the device 100. In such embodiments, the icon button may be referred to as a menu or home button. In some other embodiments, the menu or home button may be a physical push button or other physical input/control device instead of the icon button.

In a preferred embodiment, an App Billboard management module 137 is loaded into memory 102, which provides a portal between the operating system 126 and the App Billboard applications. An App Billboard application is the full version of a device application loaded in memory 102 that has a lite version component or an App Billboard associated with it. In other embodiments, the functions of the management module 137 and its portal may be built into the operating system 126 and accessed through the operating system settings. The management module 137 interfaces with any security protocols executing on device 100 that provides permissions to allow a configured App Billboard to be executed on device 100. This will allow the user to manage the App Billboard applications both on the system level through the management module 137 and at the application level through security permissions. The management module 137 via its portal is a key element to the effectiveness of the App Billboard, as it allows multiple App Billboard applications on the same device to have App Billboard functionality without causing conflicting processes and opposing displays for an equivalent event trigger. The portal creates the process that allows the desired App Billboard to display and deprioritizes other functions of device 100. In still another embodiment the portal as described above, could also be built into an App Billboard application.

Whether the App Billboard portal is built into the operating system, as a stand-alone management module 137, or in an App Billboard application, the portal will allow the user of device 100 to define what priority is received by an App Billboard application for an event trigger based on specific programmable parameters. The portal may for example, have the user select an App Billboard to display every time the device is unlocked or only the first time of the day. The portal may be programmed, for example, to allow the user to select a different App Billboard to display when the device is turned on, unlocked, enters or exits a location, or to let the full version of the App billboard capable application determine when an event triggers activates the App Billboard display. The portal may also, for instance, put limitation on an App Billboard application that restricts an App Billboard from being triggered unless the device is in an unlocked state, or be automatically muted during certain times of the day. This allows the user to select the individual App Billboards that are related to their interests or needs during different times or activities during a 24-hour period.

In a preferred embodiment, the portal will also have either or both: the option to stop or limit App Billboards based on the power capability of the power system 162, data availability of the RF subsystem 108 and computing power of the CPU 120. The portal providing a selectable option that limits an App Billboard's power consumption and data usage using an algorithm that calculates the amount of CPU power each App Billboard is consuming. As may be elected and defined by the user or calculated via the algorithm, the portal may use average usage patterns for a typical weekday or weekend for a particular season of the year and manage the power level and data usage accordingly. The portal also has the capability to stop all App Billboards from activating if it detects that the device 100 is overheating due to the CPU 120 load.

The portal may operate in conjunction with a server using external port 124, or the RF subsystem 108 and browser application to access the internet in order to effectively handle various tasks requiring data from a server. Additionally, the portal will prevent App Billboards from activating when a user is actively interacting with another application operating on the device 100, such as for example, the telephone application.

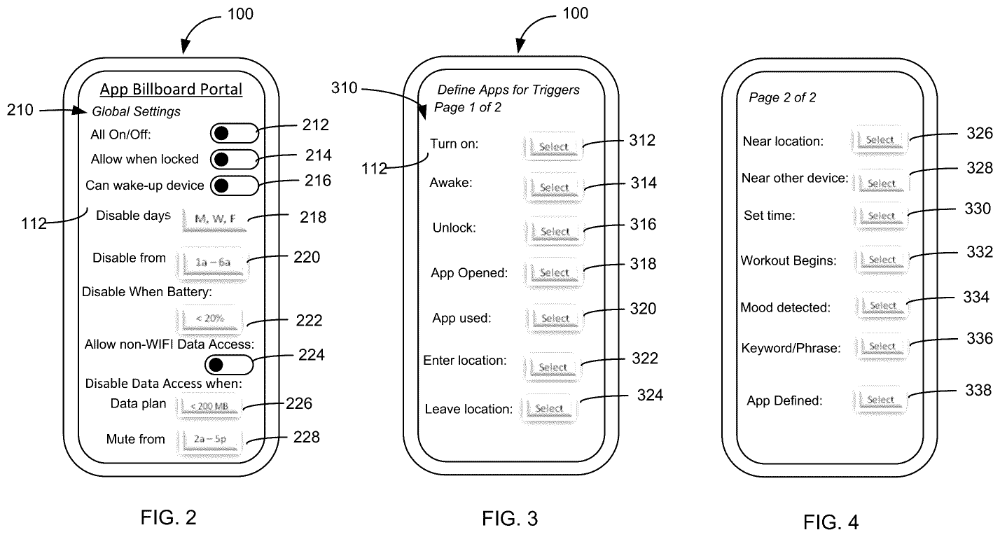

FIG. 2 illustrate an example of an App Billboard portal 210 that in conjunction with touchscreen 112, display controller 156, contact module 130, graphics module 134, text module 135 and management module 137, provides a GUI interface to the management module 137, the operating system 126 or to an App Billboard application. Portal 210 may also be used as a GUI between the operating system 126 having App Billboard portal settings or an App Billboard application.

FIG. 2 illustrates the global settings of portal 210 with the screens of FIGS. 3-4 illustrating additional portal screens 310, 410 accessed by the vertical scrolling of display 112. The global settings of portal screens 210, 310 and 410, apply important restrictions and definitions universally across all App Billboards when interfacing with the management module 137, or operating system 126 settings and override individual App billboard application settings.

It should be noted that all of the graphical icons used to make configuration selections on the screen 112 are touch-sensitive. That is, a selection can be made for a function by touching the icon with a users finger or a stylus. In the present disclosure when making a selection, the terms selecting, or selecting the icon signifies touching the screen 112 where the icon is located.

The global settings 210, includes an icon 212 that may be manipulated by the user to turn-off or alternatively turn-on all App Billboard applications from displaying on screen 112. Icon 214 when set in an on-position allows an App Billboard application to display on screen 112 when the device is locked and when in the off-positon when unlocked. There may be security considerations to some users that do not want an App Billboard to display when the device is locked. This would effectively cause all App Billboards that normally show when device 100 is turned-on or awakened to load as a hidden screen until the device is unlocked.

Icon 216 is used to select if the device 100 can be awaken by an App Billboard trigger. The user can select via management portal 210 to allow an App Billboard application to actively wake up the device 100 and display the App Billboard without any action being taken by the user.

Icons 218 and 220 limits the App Billboard applications to not display during certain days of a week or hours of the day. This function would be used by users that have schedules that require App Billboard applications to be prevented from displaying on certain days of a week or times during a day, perhaps due to for example, a work policy. The icon 218 would select the days a App Billboard is disabled by repeatedly touching icon 218 until the desired day is shown. Similarly, icon 220 may be repeatedly touched until a time period, for example 1 am-6 am is shown on icon 220, thereby setting when, during the day, an App Billboard application is disabled.

Icon 222 when repeatedly touched by the user scrolls through a series of selectable minimum power setting thresholds wherein the App Billboard application does not execute on device 100. For example, FIG. 2 shows icon 222 set at a threshold of <20%, representing that an App Billboard application will not be executed and an App Billboard displayed if the power available to device 100 has fallen bellow 20% of its capacity. Since an App Billboard application uses the resources of device 100, such as for example the CPU 120, memory controller 122, audio subsystem 110 and speaker 111, etc., the App Billboard application may consume power from the power system 162, such as a battery to a point where the device 100 stops operating and closes. Icon 222 provides the ability for a user to auto disable an App billboard application from running to save battery life as to not drain the device's 100 battery down to zero when a minimum power threshold is reached.

As was explained above, some App Billboard applications may be operated to be completely functional offline. Some App Billboard applications may be setup to operate with external data, such as for example an App Billboard application that requires a connection to other external remote devices, to a server, or global resources in the cloud using the internet. In such cases, a user may wish to only allow that connection through the RF subsystem using a WiFi communication protocol rather than a paid metered data plan connection such as GSM or EDGE communication protocols. Icon 224 allows a selection that limits data access to only WiFi access. This selection provides a way for the portal to manage the way the App Billboard application transmits and receives data on device 100. In certain situations, such as for example when the device 100 is not able to connect to a WIFI signal, a user may still use a metered data plan but limit the amount of data that an App Billboard my use in the data transmission. Icon 226 when touched allows for a maximum threshold rate of data use to be selected in order to prevent the user to from being charged data overages. For example, as shown in FIG. 2, a selection of less than 200 MB by icon 226 would curtail the use of data using a paid metered data plan when the 200 MB threshold is reached.

Icon 228 allows a user to select a function that universally mutes the audio that may be used by an App Billboard and played back through speaker 111. The audio playback may be muted for any App Billboard application used by device 100. For example, icon 228 shows a selection that mutes the audio of all App Billboards between the hours of 2 am and 5 pm.

In certain embodiments, event triggers are setup in the portal or preloaded in the App Billboard application that initiate and execute the App Billboard application. The App Billboard application uses the embedded resources of device 100, its modules, permissions, and the operating system 126 settings of the device 100. In a preferred embodiment, the App Billboard application, management module 137, processor 120 and I/O subsystems 106 are designed to communicate with each other using a data communication protocol designed to create a universal and consistent code structure to allow the operating system 126 to recognize when an event trigger has occurred and to which executing App Billboard application to apply the event trigger to display on the device 100. This communication protocol will be referred to herein as an “App Hook”.

These App Hooks will allow the operating system 126 to send packets of data information to the management module 137, or the portal of an App Billboard application, that informs via the portal that various events have taken place on the device 100, such as for example, the device 100 is turned on, the device 100 awakened from sleep, the device 100 is unlocked, the GPS location data changes, a certain application is opened, a certain application is in a running state, or when the internal clock of the device changes. The App Hook may also provide information and data to the operating system 126 from the management module 137 or the App Billboard application of user selected or automatically configured event triggers set in the portal 210.

An App Billboard application utilizes an event listener to know when an event has taken place that causes a trigger for an App Billboard application. The application then makes a request using the App Hook to the operating system 126, either directly or through the management module portal 137, to display the App Billboard.

In some embodiments, App Hooks will require a universal application code (UAC) that will function as a token to identify an App Billboard application across multiple devices. The UAC can be programmed into each App Billboard application and into various event listeners and App Hooks to easily identify the location of different App Billboards across connected devices and where data is being sent and received from. Additionally, the UAC may require the registration of a device 100 with a carrier or manufacturer to further assist with identifying the operating system that is being communicated with.

An applications executable on device 100 may have an event listener configured to connect to App Hooks or other technological processes such as using Hypertext Transfer Protocol (HTTP) requests. The HTTP requests having the ability to tell an App Billboard application that a specific event has taken place. In some embodiments, a hybrid solution of App Hooks and HTTP requests can be used to communicate with an application event listener. The hybrid solution configured to switch between the HTTP requests and App Hooks, to translate between them, and optimize which is best to be used in different use cases based on security requirements and what event listeners are being utilized. For example, in some embodiments, the application event listener will receive HTTP requests detailing relevant information from the outside world when certain events take place. In some embodiments, there may be a chain of event listeners within various applications that specialize in listening for specific event cues and these different event listeners may send HTTP requests to one another before sending an HTTP request to the App Billboard application.

The management module 137 acts as middleware, or a bridge between the operating system 126 and the App Billboard applications. In a preferred embodiment, the operating system 126 and management module 137 would monitor various events or processes happening within the operating system 126 operating device 100. In this embodiment, the operating system 126 only needs to send data packets to only the management module 137 concerning events that take place, rather than to every App Billboard application executing on device 100. The management module portal will distribute the event information, via App Hooks or other currently known data transfer protocol, to those App Billboard applications that have been set by the user to be associated with a particular event trigger. This will help reduce the number of event listeners being active on a device at any given time and lower the processing requirements for the App Billboards that may be executing on a device. Additionally, device security is improved by having the management module 137 tell the operating system 126, via an App Hook, when an App Billboard needs to be activated and displayed and what App Billboard should be activated and displayed on the device 100. For example, if the App Billboard activates when the device is in a locked state, then special considerations may be made between the management module 137 and the operating system 126 to protect the security and integrity of the device 100, resulting in a restricted App Billboard operating state. In order to move out of the restrictive operating state to open the App Billboard application for example, the user will need to unlock the device via the user's defined method. When the App Billboard is regulated to only operate after the device is awake or unlocked, then it will load a hidden window in preparation for the restrictive parameters to be lifted and then the window will be unhidden and displayed after detecting the restrictive parameter is no longer applicable.

The data, information, text, audio content, video or visual content, vibrating or interacting features of an App Billboard will be controlled and updated by the full version of a device application that has an App Billboard associated with it. The App Billboard may pull from cached data and resources downloaded and saved to the device (offline use) or streamed directly from the Internet, much like current applications are operated. There may be App Billboard applications that are created for the sole purpose of displaying an App Billboard and the App Billboard application exists solely to manage user options, preferences, permissions or event listener for the App Billboard. Additionally, certain App Billboard applications may, for instance, have a benefit of promoting certain products or services to users and may have an App Billboard that displays advertisements. Since a portal allows the user to choose how a device utilizes App Billboards, the user can end all App Billboards from a particular App Billboard application by simply uninstalling the device application.

In some embodiments, device manufacturers or data service carriers may pre-load an App Billboard application on a device and make the App Billboard be required to default to a particular event trigger that the user agrees to have setup when accepting the device. For example, device manufacturers or data service carriers may pre-load the management module 137 and its portal on a device 100 with several event triggers corresponding to a preloaded App Billboards setup for the user before the user receives the device 100.

The App Billboard application is not dependent on a user touching a screen, providing finger contacts, using gestures, showing their face, or other user interactions including the invoking of a device application to launch. These different activities may cause a system process to begin, but it is the system process through the operating system 126 and management module 137, via the portal that links to event triggers that activates the App Billboard application rather than the user input or action itself. Examples for various event triggers are illustrated in FIGS. 3 and 4 that may be activated and configured by a user using the App Billboard portal 210. It should be noted that the event triggers listed in FIGS. 3 and 4 are not exhaustive and are not the only event triggers that can be used to configure the portal 210.

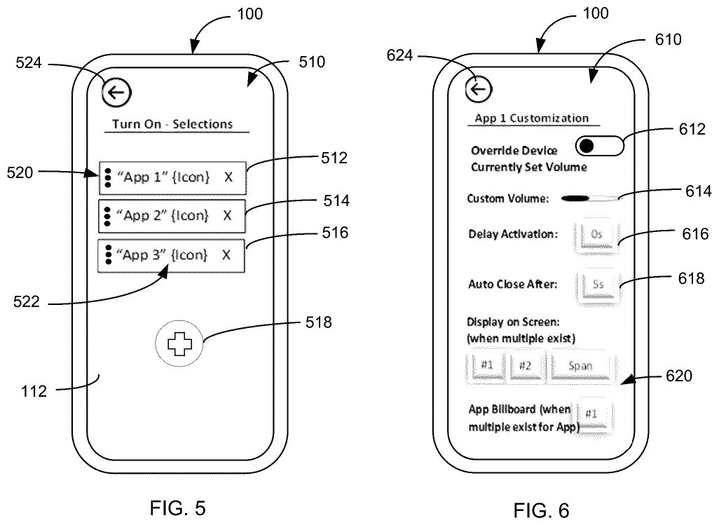

Each icon listed on the event trigger screens 310 may be activated to provide global settings for an App billboard application executing on device 100. Selecting any of the selection icons 312-338 displays a selection screen that lists configuration selections for each individual icon on the event trigger screen 310. For example, selecting icon 312 would bring up a turn-on selection screen 510 shown at FIG. 5. Screen 510 lists the App billboards loaded in the device 100 for the particular event trigger selected in screen 310. In the example of FIG. 5 the App Billboard applications are listed as “App 1”, 512, “App 2”, 514 and “App 3,” 516. It should be noted that the name used (e.g. App 1) for each App Billboard application listed on screen 510, is shown for reasons of simplicity in explaining the operation of the App Billboard selection screen 510. The names could be the full name of the App Billboard application and would include an icon, ((Icon)) identifier unique to the App Billboard application. The App Billboard applications loaded into memory 102 of device 100, loads options in the portal selection screen 510 for the particular event triggers that the App Billboard application was designed to utilize. The user only needs to touch the “X” shown for each App Billboards 512, 514, 516 listed on screen 510 to remove it from executing on device 100. To reactivate a turned-off App Billboard application the user would touch the “+” icon 518 and search for it from available App Billboard applications programmed to respond to the “+” trigger to restore it. Touching the “3 circles” 520 shown for each App Billboard application 512, 514, 516 allows the user to drag and drop each App Billboard application listed on screen 510 in order to re-order the priority of how the App Billboards execute on the device 100 for the particular event trigger selected on screen 310. Selecting by touching the area 522 of each app name and icon will open up a customization display 610 for the selected App Billboard application. Touching icon 524, would return the display 112 back to the event triggers screen 310. Touching icon 624, would return the display 112 back to the selections screen 510.

The customizations listed on screen 610 would be specific to the App Billboard application being customized but would be overridden by the global settings of FIG. 2. These customizations provide controls to allow the user to override the currently set volume for a music setting 612 and set a specific volume for the App Billboard application using a volume setting 614 independent of the device set volume.

Selection of icon 616, will allow the App Billboard activation to be delayed. Repeated presses of icon 616 would cycle through a selection of delay intervals. In the case where a higher priority App Billboard application has a delay that is longer than one of a lower priority App Billboard application the lower priority App Billboard will display until the delay has been satisfied. An auto close feature 618 is useful when a user is not by the device or is distracted and may be set to various time intervals that closes the App Billboard or have an indefinite time set requiring manual closing of the App Billboard. Repeated pressings of icon 618 would cycle through a set of intervals (in seconds).

Since the App Billboard is designed to fill the screen it is helpful to be able to define how an App Billboard screen should fill display 112 if multiple screens are active for the device 100. Certain App Billboard applications my have App Billboards that have multiple App Billboard screens for the same App Billboard. For example, an App Billboard that displays a graph of stock performance for each of a multiple number of stocks. Touch screen icons 620 allows the user to define how the multiple screen app billboard is displayed on the screen 112.

In the present embodiment the selection of the “Awake” 314 and “Unlock” 316 icon shown on the event trigger screen 310 would invoke customization screens similar to the turn-on screen 510 and customization screen 610. Other selections on the event trigger screen 310 may invoke additional options, customizations and selections on screen 510 and 610 that are not shown but are described below.

The “App Opened” 318 icon identifies what applications to track. Applications selected to be tracked in a selection screen will cause a data packet of information to be sent to notify the listed App Billboard applications event listener that a tracked application has been opened. The App Opened selection may be further customized to identify that an application applicable to an App Billboard is being customized for the event trigger.

The “App used” 320 selection identifies what application to track and the amount of time that needs to pass to qualify that the application is being used. Applications being tracked will cause a data packet of information to be sent to notify the listed App Billboard application's event listener that a tracked App has been used for a set duration of time. The App used selection 320 can be further customized to identify in a selection menu, which application(s) used will trigger the particular App Billboard.

The “Enter location” 322 and “Leave location” 324 icons are used to identify what locations to track when the device 100 enters or leaves a specific location. Increasingly users and device operating systems are locking down and preventing 3^{rd} party apps from accessing device location data. By having the portal monitor have access to the location data as a middleware, allows location data provided by the GPS module 135 to trigger App Billboards without requiring the App Billboard application itself to have full time access to the device's location data. Locations that are specified to be tracked will cause a data packet of information to be sent to notify listed App Billboard application's event listener that the device has entered or departed a specific or tracked location. Additionally, the App Billboard application may have the ability via a selection screen to set a distance circle surrounding the locations being tracked to qualify as entering or leaving a location. A selection screen would be used for entering the location data, and distance circle information and which location or locations will trigger the particular app billboard being customized. Additionally, the selection screen may include configuration selections to allow the app billboard being customized to wake up the device 100 and whether to allow it to activate when the device is locked or not.

Unlike the Enter or Leave location triggers, the “Near location” selection 326 is less definitive and can be dynamic. This selection would require that a monitoring app be defined in a Selections screen to specifically detect the users desired location trigger. A monitoring app for a near location function could be a map application executing on the device 100. The map application would determine when the type of location is within the defined range. In a preferred embodiment, the type of location(s) would be defined by the user in the selection screen. Once the location is near, the monitoring app will notify the list of App Billboard applications that the event has taken place. For example, this selection could monitor a type of location, such as “resturants”, that whenever the device nears a restaurant it could trigger certain App Billboards to load. In another example, a gaming app may use augmented reality over real life places that would provide location of a “reward depot”. Whenever the device 100 nears a location of a reward depot an event trigger would activate an App Billboard related to the gaming App.

The “Near other device” selection 328 would specify discovery of new devices using a Bluetooth scan. Selection of this event trigger would bring up a selection menu specifying what known devices should be tracked to cause the event trigger when within range of the known devices. The selection menu would be able to receive data of the known devices being tracked and which known tracked devices will trigger the particular App Billboard being customized. Additionally, there could be options to allow an App Billboard being customized to wake up the device and whether to allow it to activate when the device is locked or not.

The “Set time” selection 330 specifies specific times during a 24 hour period that the users wishes to have an event trigger occur. This allows the user to schedule a specific App Billboard to run via the portal at the specific time. This is different than having a custom event defined within the portal settings that define a time to activate or to track the passage of time in order to trigger the App Billboard. Selection of the Set time event trigger 330 would bring up a selection menu containing specified times that will trigger the particular App Billboard being customized.

The “Workout Begins” selection 322 detects when the user has begun a workout routine. This would be used most likely with a fitness monitoring application. Once the workout is identified as happening, the monitoring application notifies the App Billboard that the event has taken place. Selecting this event trigger would bring up a selection menu that would set a duration by which the workout takes place before the event trigger activates. For example, the user specifies that the workout needs to be consistently active for 10 minutes before this event will trigger. The selection menu may also provide options to allow the App Billboard being customized to wake up the device and whether to allow it to activate when the device is locked or not.

The “Mood detected” selection 334 detect when the user has expressed a particular mood. This selection works in conjunction with a monitoring application such as for example, a mood tracking application, that tracks a users moods and feelings. Once a mood is identified as happening the monitor application will notify the App Billboard that the event has taken place. The selection screen would have the ability to set the types of moods to be monitored by the App Billboard, such as for example, anger, depression, and sadness.

The “Keyword/Phrase” selection 336 specifically detects, using a monitoring application such as for example, a voice assistant application executing on device 100, a keyword or keyphrase is spoken by the user. Upon detection of a selected keyword/keyphrase the monitoring app would notify the App Billboard that the event has taken place. Keywords/phrases would be selected or entered and tracked in a selection menu. The App Billboard application using the Keyword/Phrase selection 336 could be further customized in the selection menu as to which keywords/phrases are an event trigger for a particular App Billboard.

The “App Defined” selection 338 would be used to monitor App Billboard applications that contain event custom triggers and better control their App Billboard activation. Selecting this app defined custom event trigger selection would call up a selection menu with custom trigger setups. Each custom trigger specific to a particular App Billboard application would be defined and setup within the App Billboard application and displayed in the selection menu. The selection menu settings within the App Billboard application for a custom trigger would execute as a monitoring application determining from the device 100 external or internal resources that an event took place. For example, using an internal resource to the device 100 or an external source such as the internet. The App Defined selection 338 identifies the custom event triggers for all the App Billboards that could be activated on the device 100 and allows the user to define if they should be allowed to activate, awake the device 100, or show when device 100 is locked. This app defined custom event trigger menu is also where custom groupings of multiple various triggers could be setup. For example both a workout routine beginning and the device 100 at or near a location, such as a gym, need to both trigger before the App Billboard will display. In this case the application that is displaying the App Billboard would need to be in the Selections menu of both the workout routine and near a the location triggers and be setup with this particular customization in the full version of the app settings. Apps listed in the Selections menu would be allowed to activate based on app defined custom triggers and their given priorities. In a preferred embodiment there would be an option for the user to state that only App Billboards with these custom triggers will be allowed to be displayed if they are listed here.

In a preferred embodiment, a custom event trigger would be an application that receives a push notification that triggers an App Billboard to display information contained in the notification. The notification and any additional media and inter-related actions could be displayed by the App Billboard. For example, an external platform that sells video games could send a notification to the device 100 that a new game has launched on the platform. The notification would trigger an App Billboard to open with a cover of the new game and an option to download the game within the App Billboard. Since a notification for a particular application can be selected as a custom event trigger the user is no longer required to scroll through various notifications to find the one the user desires to utilize. This will allow users to have App Billboards launch for applications they care the most about and relegate the applications they care less about to the notification text window.

Another use case for custom event triggers can come from a stackable workflow of multiple communications and event listeners where one application is monitoring for an event that then sends a communication to an event listener in the application with an App Billboard associated with it to trigger the App Billboard. For example, an application in a car entertainment system that monitors an automobile's functions could detect that an accident has taken place which communicates to an application via Bluetooth on the driver's device 100 that an accident took place and its severity. The application on the driver's device 100 then sends a communication, such as a voice call, or text message using a telephone function of the device 100 to an emergency contact's telephone that an accident took place, its severity and GPS location of where it happened. An event trigger set on the device 100 would trigger an App Billboard to display on the emergency contact's device, identifying the person having the emergency, the address of the accident, the severity, and providing the option to call the driver's phone or emergency services. Selecting emergency services by the emergency contact causes the device 100 to call the emergency service number to assist in the accident.

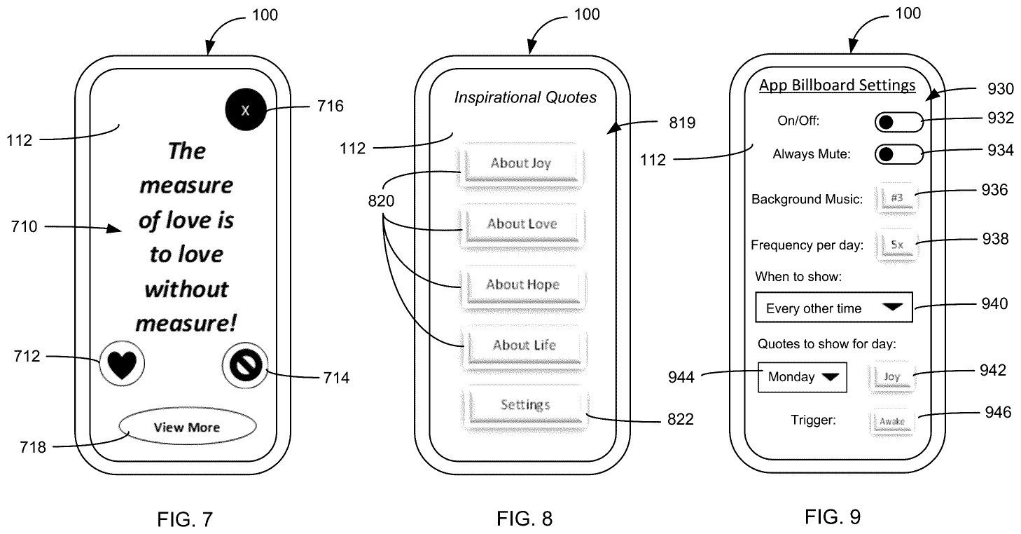

FIGS. 7-9 illustrates an example of an App Billboard and its various selection screens. In the App Billboard example, the App Billboard when executed displays inspirational quotes on screen 112. The App Billboard 710 is displayed after an event trigger occurs such as when device 100 is awakened from a sleep mode. The touch screen 112 of the App Billboard displays the inspirational quotes text 710 and numerous interactive icons 712, 714, 716 and 718. Thematic music may be played by the music player application through the speaker 111 as may be designated by the user in the App Billboard portal. The heart icon 712 when selected by the user affirms to the inspirational quotes application that the user likes the quote. A confirmation signal, such as a vibration or tone from the speaker 111 may be used to confirm the selection. The favorable selection enters a positive preference for the quote to the inspirational applications data table in memory 102 in order to track the user's positive preference.

The cancel icon 714 when selected by the user signals that the user dislikes the displayed quote and logs an unfavorable preference for the quote. As was done above, a vibration or audio signal may be used to confirm the selection. The unfavorable preference is posted to the inspirational application data table in memory 102 to track which quotes are not to be showed to the user in the future. Selecting the heart icon 712 or cancel icon 714 will not cause the device to navigate away from the App Billboard. The “view more” icon 718, will open the full version of the inspirational quotes App Billboard application on the device 100. The view more icon 718 is not displayed on touchscreen 112 until the user unlocks device 100, using the appropriate unlock routine for the device.

The “X” icon 716 closes the App Billboard application and returns device 100 to a normal device GUI touchscreen interface or to the device's home screen. When the App Billboard is closed, the closing action is tracked in the inspirational quotes App Billboard application causing the application to change the inspirational message displayed in the App Billboard the next time the App Billboard is activated by the designated event trigger.

FIG. 8 illustrates an example of the selection screen 819 of the full version of the inspirational quote application. The full version of the inspirational quotes App Billboard application may be manually opened from the home screen of the device 100 by touching its application icon, from a notification, or from selecting the view more icon 718. Upon entering the selection screen 819, a number of categories of inspirational quotes are displayed to the user as icons 820. Each selection icon 820 when selected by the user, would allow the user to scroll through a number of text quotes within a specific category 820. For example, selecting the “About Love” icon 820 would display to the user a number of inspirational quotes about love that could be selected for display as the inspirational quote text 710 on the App Billboard screen 112. The selection screen 819 also includes a settings icon 822. The settings icon 822 is used by the user to enter an App Billboard settings portal to customize certain operations of the App Billboard application.

FIG. 9 illustrates the App Billboard Settings screen 930, that is displayed on touchscreen 112 of device 100 when the settings icon 822 is selected. The settings screen 930 provides several options to the user, such as for example, the ability to turn the App Billboard off using icon 932 which prevents operation of the App Billboard in case the user no longer desires to use it. Conversely, the user may turn the App Billboard back on using the icon 932.

The settings screen also includes an icon 934 that provides the ability to mute the App Billboard in case the user does not want music to play through speaker 111, when they App Billboard displays the inspirational quote 710. If the App Billboard is not muted, the settings screen 930 includes an option to provide a selection of background music to be played by selecting icon 936 and listening to the various musical themes to select one of the selections to be played.

The user is further provided with the ability to select the frequency that the App Billboard displays its inspirational quote 710. Icon 938 allows the user to select how many times during the day the inspirational quote 710 is displayed. Repeatedly selecting icon 938 allows the user to select how many times during the day the App Billboard displays the inspirational quotes 710. The “Frequency Per Day” selection may be set between 1 to 20 times a day or every time a trigger is invoked. The “Frequency Per Day” function allows the user to better customize how many times during the day the App Billboard will display an inspirational quote 710. Upon displaying the last selected quote 710 the inspirational quote App Billboard is turned off until the next day, whereby the frequency count resets and resumes again as set by the frequency per day by icon 938.

In other embodiments, users may want the App Billboard to be displayed the first time only, every other time, every time, or some other variation of when the App Billboard trigger occurs. This is selected using a dropdown menu by box 940. For example, a user may want to see the App Billboard five times a day every other time device 100 is awakened from sleep. After the user wakes their device 100 for the 12^{th} time in the day, the App Billboard will not display. These frequency settings allow the user to better customize how much they want to see the App Billboard without getting overwhelmed or annoyed by the App Billboard displays.

The settings screen 930 further allow the user to customize the operation of the App Billboard by selecting a day of week and then selecting the category of quotes that will show on that day. The user could select quotes about Joy using icon 942 and then selecting box 944 to select display of the quotes Monday through Wednesday, quotes about Life on Thursday, quotes about Love on Friday, and no quotes on Saturday and Sundays.

The trigger selection icon 946 select between various event triggers when the App Billboard activates. For example, icon 946 can select between awake or unlock. In the case of awake, the App Billboard will be shown every time the device is awakened from sleep mode. In the case of unlock, the user can wake their device without triggering the App Billboard, however the App billboard will display after the device is unlocked. This setting functionality can be expanded depending on the particular event used by App Billboard as an event trigger. In another embodiment, the App Billboard trigger could be set-up to both show upon awake and then show again upon unlock. Additionally, the App Billboard may not offer the trigger option 946 in the App Billboard Settings 930 if an option is provided in the App Billboard management portal 210.

The above shown functions of an inspirational quote application correspond to a set of configuration selections for performing one or more functions described above. These selections shown in FIGS. 7-9 are used herein as examples and need not be implemented as indicated in screens 710, 819 and 930. The icons and their selections and functions may have different functionality than what is shown in screens 710, 819 and 930, may be combined, or a may have a different configuration or arrangements based on the type of App Billboard application that is being implemented.

It may be advantageous to set forth definitions of certain words and phrases used throughout this patent document. The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims is intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” or “controller” within a claim is understood and intended to refer to structures known to those skilled in the relevant art, as further modified or enhanced by the features of the claims themselves and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

1. A method comprising:
at a portable computing device having a display and a plurality of resources available for use by the portable computing device:
providing a digital application on the portable computing device selectable for execution on the portable computing device by a user of the portable computing device;
providing a lite version component of the digital application;
providing a management module having a management portal displayed to the user of the digital application on the display, wherein the management portal comprises of at least one user selectable configuration selection for the lite version component of the digital application;
configuring by the user using the management portal the digital application to execute the lite version component of the digital application using the at least one user selectable configuration selection; and
displaying the lite version component on the display, wherein the configuration selection deprioritizes at least one of the plurality of portable computing device resources when the lite version component is executed.

2. The method of claim 1, wherein the management portal displays to the user of the digital application global settings comprising of the at least one user selectable configuration selection for the lite version component of the digital application.

3. The method of claim 2, wherein the plurality of portable computing device resources comprises of at least one of, audio, graphics, graphics user interface (GUI), text, video and interactive elements used by the portable computing device.

4. The method of claim 3, wherein the global settings portal further includes:
displaying to the user at least one user selectable event trigger for the lite version component of the digital application; and
selecting by the user a displayed event trigger.

5. The method of claim 4, wherein the portable computing device has a locked and an unlocked state and the event trigger can be invoked in both the locked and the unlocked state.

6. The method of claim 4, wherein the portable computing device includes a plurality of digital applications executing on the portable computing device that include lite version components and the portable computing device includes a management module wherein the management module applies the user selectable configuration selections and event triggers to all of the lite version components of the digital applications executing on the portable computing device.

7. The method of claim 4, wherein the management portal includes an event listener associated with an event trigger that interfaces the digital application and resources available to the portable computing device that when selected by the user, causes the lite version component of the digital application to be displayed.

8. The method of claim 7, wherein an event listener associated with an event trigger interfaces with the resources available to the portable computing device to provide signals to the lite version component displayed on the display that an event trigger has occurred.

9. The method of claim 7, wherein the portable computing device audio resource includes a microphone, the method further comprising:
entering using the microphone a keyword or phrase into the portable computing device;
selecting an event trigger for recognizing the keyword or phrase;
associating an event listener with the event trigger; and
displaying the lite version component on the display when the event listener recognizes the keyword or phrase.

10. The method of claim 3, wherein the user selectable configuration selection is presented to the user as a graphics icon that when touched by the user invokes the selection in the lite version component of the digital application.

11. The method of claim 4, wherein the user selectable event trigger is presented to the user as a graphics icon that when touched by the user invokes the selection in the lite version component of the digital application.

12. The method of claim 6, wherein the portable computing device can display to the user a selection of more than one lite version component of the plurality of the digital applications.

13. The method of claim 12, wherein the user can select one or more lite version components of the plurality of digital applications.

14. The method of claim 12, wherein the portable computing device allows the end to select one of the more than one lite version components of the plurality of digital applications to be displayed on the portable computing device display.

15. A portable computing device comprising:
at least one processor,
a display;
a memory;
a plurality of resources available for use by the portable computing device;
at least one digital application and a lite version component of the digital application stored in the memory;
a management module stored in the memory having a management portal, wherein the digital application is configured by the management module to be executed by the at least one processor, with instructions for:
displaying to an end user of the digital application on the portable computing device the management portal comprising of at least one end user selectable configuration selection for the lite version component of the digital application;
configuring by the end user using the at least one user selectable configuration selection the digital application to execute the lite version component of the digital application; and
display the lite version component of the digital application on the display, wherein the configuration selection deprioritizes at least one of the plurality of portable computing device resources.

16. The device of claim 15, wherein the management portal
displays to the end user of the digital application global settings on the display comprising of the at least one end user selectable configuration selection for the lite version component of the digital application.

17. The device of claim 16, wherein the plurality of portable computing device resources comprises at least, audio, graphics, graphics user interface (GUI), text, video and interactive elements used by the portable computing device.

18. The device of claim 17, wherein the global settings portal displays to the end user at least one selectable event trigger for the lite version component of the digital application selectable by the end user.

19. The device of claim 18, wherein the portable computing device includes a plurality of digital applications that each include a lite version component, the management module configured to apply the end user selectable configuration selections and event triggers to all of the lite version components of the digital applications contained in the memory of the portable computing device.

20. The device of claim 18, wherein the management portal includes an event listener associated with an event trigger that interfaces the digital application and the resources available to the portable computing device that when selected by the end user causes the lite version component of the digital application to be displayed, and to provide signals to the lite version component.
